(19) United States
(12) Patent Application Publication
(10) Pub. No.: US 2025/0373535 A1
(43) Pub. Date: Dec. 4, 2025

(54) EFFICIENT ALL-TO-ALL COLLECTIVE COMMUNICATION SCHEDULES FOR DIRECT-CONNECT TOPOLOGIES

(71) Applicants: RTX BBN Technologies, Inc., Cambridge, MA (US); University of Washington, Seattle, WA (US)

(72) Inventors: Prithwish Basu, Westford, MA (US); Jason Fantl, Cambridge, MA (US); Siddharth Pal, Silver Spring, MD (US); Joud Khoury, Southborough, MA (US); Arvind Krishnamurthy, Seattle, WA (US); Liangyu Zhao, Seattle, WA (US)

(21) Appl. No.: 19/170,196

(22) Filed: Apr. 4, 2025

Related U.S. Application Data
(60) Provisional application No. 63/655,645, filed on Jun. 4, 2024.

(51) Int. Cl. H04L 45/03; H04L 45/128; H04L 45/655

(52) U.S. Cl. CPC H04L 45/03; H04L 45/1283; H04L 45/655

(57) ABSTRACT

A method of performing all-to-all collective communication scheduling includes scaling a max concurrent multi-commodity flow (MCF) framework by decomposing a MCF problem and parallelizing the MCF problem to perform a fast link-based all-to-all schedule computation. The method further includes computing a time-stepped version of the MCF problem for a host-based forwarding network topology, utilizing the time-stepped version of the MCF problem to create a direct-connect graph, and then using the direct-connect graph to compute time-stepped MCF schedules to manage a mixed topology. The method further includes identifying a direct-connect topology to perform all-to-all collective communication based on the time-stepped MCF schedules.

### CROSS-REFERENCE TO RELATED APPLICATIONS

This application claims the benefit of U.S. Provisional Application No. 63/655,645, filed Jun. 4, 2024, the disclosure of which is incorporated herein by reference in its entirety.

### GOVERNMENT LICENSE RIGHTS

This disclosure was made with Government support under HR0011-20-C-0089 awarded by DARPA. The Government has certain rights in the disclosure.

### BACKGROUND

All-to-all collective communications is widely used in machine learning (ML) and high performance computing (HPC) workloads, and optimizing its performance is of interest to both ML and HPC communities. All-to-all is a particularly challenging workload that can severely strain the underlying interconnect bandwidth at scale. For example, all-to-all collective are often a bottleneck in machine/deep learning (ML) and high performance computing (HPC) workloads. However, several challenges arise when computing all-to-all schedules such as, for example, scaling schedule generation to supercomputer scale topologies (e.g., about 1000 nodes), and lowering solutions to diverse ML (e.g., host-based) and HPC fabrics technologies (e.g., NIC-based).

### SUMMARY

The present disclosure takes a holistic approach to optimize the performance of all-to-all collective communications on supercomputer-scale direct-connect interconnects. One or more embodiments address several algorithmic and practical challenges in developing efficient and bandwidth-optimal all-to-all schedules for any topology and lowering the schedules to various runtimes and interconnect technologies. One or more embodiments also propose a novel topology that delivers near-optimal all-to-all performance.

In a non-limiting embodiment, formulation and algorithm for scaling the max concurrent multi-commodity flow (MCF) framework is provided by decomposing the MCF problem and parallelizing it for fast link-based all-to-all schedule computation.

Formulation and algorithms for computing a time-stepped version of MCF (e.g., for host-based topologies).

For switched topologies, using MCF and creating a direct-connect graph with the same “effective bandwidth, thereby removing switches, and then using this graph to compute time-stepped MCF schedules. This allows a communication system to handle and manage mixed topologies (e.g., direct-connect links as well as switch-to-host and switch-to-switch links for all-to-all communication topologies.

Application of the MCF framework in a direct-connect setting on fabrics with or without additional forwarding bandwidth and/or cut-through routing where the following cases are considered: (a) source-routing might be available or not; (b) host-to-NIC link might be bottlenecked or not; and (c) the number of shortest paths between source-destination pairs might be small or could grow exponentially with N.

Addressing practical challenges of lowering schedules and routes to both ML and HPC runtimes and interconnects with different routing and flow control requirements.

Identification of a direct-connect topology that delivers near optimal performance for all-to-all topologies (e.g., generalized Kautz graphs for any N,d), by utilizing an analytical lower bound for all-to-all performance where the identified topology approaches the bound.

In another non-limiting embodiment, A method for performing all-to-all collective communication scheduling in a direct-connect topology is provided. The method further comprises generating a communication schedule for executing an all-to-all collective communication operation among a plurality of nodes interconnected by a direct-connect topology. The schedule defines transmission of data between nodes while optimizing communication performance. The method further comprises determining communication paths for data transfer between nodes. The communication paths are selected to optimize concurrent data transmission across the direct-connect topology. The method further comprises allocating communication resources to ensure efficient utilization of available bandwidth across the direct-connect topology, and executing the all-to-all collective communication by transmitting data among the nodes in accordance with the generated communication schedule.

According to yet another non-limiting embodiment, a direct-connect network for executing all-to-all collective communication among a plurality of nodes is provided. The direct-connect network includes a plurality of nodes, with each of the nodes configured to operate as both a source and a destination for data communication. The direct-connect network further includes a plurality of direct-connect links interconnecting the nodes, each of the direct-connect links having a defined bandwidth. The direct-connect network is structured to support concurrent communication among each of the node pairs included in the plurality of direct-connect links. The arrangement of the nodes and direct-connect links is configured to facilitate all-to-all communication scheduling by enabling each node to transmit and receive multiple data flows concurrently.

### BRIEF DESCRIPTION OF THE SEVERAL VIEWS OF THE DRAWINGS

FIG. 1 illustrates a network executing an all-to-all collective operation according to an example;

FIG. 2 illustrates a host-based forwarding network topology;

FIG. 3 illustrates a NIC-based forwarding network topology;

FIG. 4 depicts a difference between a NIC-based forwarding network topology and a host-based forwarding of flow from host H₀ to H₂;

FIG. 5 depicts a summary flowchart of the algorithms for generating all-to-all schedules for direct-connect fabrics according to a non-limiting embodiment of the present disclosure;

FIG. 6 depicts a topology augmentation to model host-to-NIC bottleneck;

FIG. 7 depicts diagrams showing throughput of link-based all-to-all schedules on different topologies and runtimes;

FIG. 8 depicts diagrams showing throughput of route-based all-to-all schedules on different topologies and runtimes;

FIG. 9 are diagrams depicting performance on punctured 3D Torus, removing 3 links or 3 edges at random and having envelope min/max/average (line) over 10 instances (20 iterations per);

FIG. 10 is a diagram depicting 3D FFT Times (N=27 processes, 32 threads each);

FIG. 11 is a diagram depicting a scaling on GenKautz (degree=4); MCF-decomp is master LP+N parallel child LPs+widest path extraction heuristic;

FIG. 12 is a diagram depicting performance on degree 4 Generalized Kautz graphs normalized by Link-based MCF;

FIG. 13 is a diagram depicting performance on N=81 Gen Kautz with links disabled normalized by Link-based MCF;

FIG. 14 is a graph depicting GenKautz topology performance relative to lower bound; and

FIG. 15 is a graph depicting expanders and 2D-Tori, normalized by lower bound.

### DETAILED DESCRIPTION

Collective communications have received significant attention in both high performance computing (HPC) and machine learning (ML) disciplines. The all-to-all collective, in particular, is used in several HPC workloads such as with the 3D Fast Fourier Transform (FFT) used in molecular dynamics and direct numerical simulations. It is also used in ML workloads, for example, to exchange large embeddings in the widely deployed Deep Learning Recommendation Model (DLRM), and in the mixture-of-experts (MoE) models. All-to-all collective communication is often a bottleneck at scale in these workloads. An emerging approach to meet these challenging demands has been to employ various forms of optical circuit switching to achieve higher bandwidths at reasonable capital expenditure and energy costs.

Hosts (e.g., the GPUs/Processors) communicate using a limited number of optical circuits that may be reconfigured at timescales appropriate for the hardware, thus exposing network topology as a configurable component. One or more embodiments refer to this setting as direct-connect with circuits that are configured and fixed for an appropriate duration. Direct-connect fabrics and topologies such as mesh, Tori, DragonFly, and SlimFly have been well studied in the HPC community and deployed across several supercomputers, such as with Google's TPUv4.

Computing bandwidth-optimal all-to-all schedules on a direct-connect topology with N nodes can be formulated using the Max Concurrent Multi-Commodity Flow (MCF) problem, and solved in polynomial time using linear programming (LP). MCF, however, suffers from high time complexity even at modest scales since the number of flow variables in a bounded degree network scales as O(N³). At N=1000, for example, even a state-of-the-art LP solver is unable to generate a schedule on a fast machine within an entire day. For smaller N (<100), which is typical of ML applications, it takes tens of minutes to generate a schedule. This makes it hard for the algorithm to react quickly to changes in the topology, for example, due to topology reconfiguration or failures. One or more embodiments enhance the scalability of the exact all-to-all MCF by decomposing it into a simpler master LP and a set of N children LPs that are parallelized for fast computation. One or more embodiments demonstrate a O(poly(N)) speed up in time complexity under decomposition and parallelization, reducing actual runtime on N=1000 by orders of magnitude to 40 minutes instead. For N in the hundreds, it takes seconds to generate a schedule. Prior works try to improve computational complexity by trading off optimality using approximation schemes. These works still end up significantly underperforming the described decomposed MCF in practice, both in terms of performance and complexity.

Another challenge lies in lowering the MCF solution to both ML accelerators and HPC runtimes and fabrics. These fabrics employ different topology, routing, and flow control mechanisms as they have historically been designed with different objectives. One or more embodiments devise a general model of the underlying network, distinguishing between fabrics that support additional forwarding bandwidth (i.e., forwarding bandwidth at the Network Interface Card (NIC) is higher than the injection bandwidth at the host/accelerator) and those that do not. Additional forwarding bandwidth increases all-to-all performance in direct-connect settings as it compensates for the bandwidth tax (since a node acts as a router and uses a significant fraction of its total link bandwidth to forward other node traffic). One or more embodiments develop an algorithmic toolchain for producing and lowering near bandwidth-optimal all-to-all collective communication schedules to arbitrary super-computer-scale topologies and different interconnect technologies. On host or accelerator runtimes where data movement is “scheduled”, a novel time-stepped version of the MCF problem is provided. On fabrics with hardware “routing” and additional forwarding bandwidth, one or more embodiments develop scalable algorithms for computing static routes either by directly extracting the paths from the MCF solution or by employing path-based MCF formulations where flow variables are defined on paths instead of on links. One or more embodiments develop compilers and tools for lowering the schedules and the routes to the underlying runtime and interconnect, and one or more embodiments demonstrate near-optimal all-to-all performance on a range of topologies at different scales.

One or more embodiments also establish an analytical lower bound for all-to-all performance on any topology, use it to compare different topologies and show the superiority of generalized Kautz graphs in terms of both performance and coverage. It is known that topologies with higher bisection bandwidth result in higher all-to-all throughput. Several works in the HPC community have investigated the all-to-all behavior of different topologies. Earlier works proposed specialized patterns for higher dimensional mesh, tori and hypercubes, while later works proposed more complex topologies that have beneficial graph properties, e.g., high expansion coefficient, large spectral gap, and low diameter. Many of the proposed topologies, however, do not have sufficient coverage in realizable graph sizes (N) and degree (k). One or more embodiments propose the class of generalized Kautz (GenKautz) graphs, which are known for their expansion properties and can be constructed for any N and k.

### Direct-Connect Fabrics for ML and HPC

The present disclosure identifies topologies and schedules helpful for a broad range of direct-connect interconnects common to both high performance computing (HPC) and machine learning (ML) accelerator fabrics. These include, for example, switchless physical circuits, patch-panel optical circuits, and optical circuit switches (OCS). These options differ in cost, scalability, and reconfigurability. For example, commercially available OCSs can perform reconfigurations in ≈10 ms, are more expensive than patch panels, but scale to fewer ports (e.g., Polatis 3D-MEMS switch has 384 ports). With these reconfigurable fabrics, topology becomes a degree of freedom, and ongoing work is demonstrating how to exploit this degree of freedom for increased performance. Despite supporting faster reconfigurations, OCSes still suffer from relatively high reconfiguration latency, precluding rewiring of the circuits during a typically-sized collective operation. Accordingly, collectives need to operate over a set of preconfigured circuits that remain unchanged for the duration of the collective operation. One or more embodiments refer to this setting as direct-connect, circuits (and topology) that are configured and remain static for the duration of the collective algorithm. One or more non-limiting embodiments target different interconnect technologies, broadly ML accelerator and HPC interconnects. These employ different topologies, routing, and flow control, as they have historically been designed with different objectives. Table 1 below highlights high-level differences between the two fabrics.

TABLE 1
Comparison of HPC and ML accelerator fabrics.

| | HPC | ML Accelerator |
|---|---|---|
| Schedules | Path-based | Link-based |
| Topology focus | Bisection bandwidth | Node bandwidth |
| Flow Control | Cut-through | Store-and-forward |
| Injection BW | B | B |
| Forwarding BW | ≥B | B |

HPC interconnects have generally focused on reducing latency using low-diameter topologies with high bisection bandwidth and hardware routing with cut-through flow control. With hardware routing, where each node or NIC serves as a router, the total forwarding bandwidth may exceed the host injection bandwidth to accommodate for the forwarding bandwidth tax. ML accelerator interconnects, on the other hand, optimize for high link bandwidth as they are mostly focused on collectives, tend not to employ hardware routing, and use synchronized accelerator schedules with store-and-forward flow control.

### All-to-All Schedules, and Throughput

The network topology is modeled as a directed graph, represented as the tuple G=(V, E), where V denotes the set of nodes (|V|=N) and E denotes the set of directed edges. The direct-connect fabric imposes a constraint that all nodes have degree d, which is the number of links/ports on each host or accelerator and is ideally low and independent of N. The link bandwidth is b, and the node bandwidth is B=db.

Each node i has a data buffer Bᵢ comprised of N contiguous and equally sized shards B_{i,j} each of sizem bytes, 0≤i, j<N, |Bᵢ|=Nm, |B_{i,j}|=m. The all-to-all collective transposes the buffers, i.e., each node i sends shard B_{i,j} to node j.

Communication schedules can operate at a finer granularity than a shard. One or more embodiments define chunk C_{i,j} to be a subset of shard B_{i,j}, both specified as index sets of elements in a shard with B_{i,j} representing the entire shard. For example, the shard can be an interval [0, 1], and C_{i,j} be some subinterval. Chunks do not need to be the same size. Since each chunk C_{i,j} has a known source node i and destination node j, one or more embodiments omit the indexes and simply use C to denote the chunk. An all-to-all communication (comm) schedule A for G with tmax comm steps specifies which chunk is communicated over which link or route in any given step. Specifically, A is a set of tuples (C, (u,w), t) with u,w∈V and t∈{1, . . . , tₘₐₓ}. (C, (u,w), t), denotes that node u sends chunk C to node w at comm step t. Chunking is performed during schedule compilation. Link-based Schedules: In fabrics without hardware routing, chunks only flow on directly connected edges (u,w) ∈EG. Path-based Schedules: In fabrics with hardware routing, (u,w) may not correspond to an edge in G, i.e., chunks can flow on end-to-end paths between source and destination as determined by the routing function.

The throughput of an all-to-all schedule for a shard size m is ((N−1)m)/T, where T is the time to complete the all-to-all schedule (the time for each node to send N−1 shards each of size “m” bytes). Finally, algorithm runtime is the time taken by the algorithm to compute and lower the schedule for a given network.

In a non-limiting embodiment, optimization of the all-to-all collective communications has been formulated as a maximum concurrent multicommodity flow problem (MCF) and solved in polynomial time using LP. Although the MCF has polynomial time complexity, it can be difficult to solve in practice for large problem sizes. As a result, several works have proposed fully polynomial time approximation schemes (FPTAS). The best known FPTAS schemes have time complexity defined as:

$$O ( \frac{{N}^{\text{?}}}{{k}^{\text{?}}} {log}^{O ( 1 )} N ) ;$$

$$\text{?} \text{indicates text missing or illegible when filed}$$

while attempting to achieve a factor of (1−∈) of the optimal throughput. One or more embodiments described herein improve the tractability of LP-based solutions while not sacrificing optimality. One or more embodiments decompose the original MCF problem into a master LP and N simpler parallelizable child LPs. Since the former (which dominates the time complexity—see FIG. 11) has O(N²) variables, one can leverage recent LP solving techniques with time complexity O(N^{2.37}) to solve the MCF in O(N^{4.74}) time. In practice, the master LP according to one or more embodiments of the present disclosure has lower time complexity owing to its special structure, and MCF is significantly better in running time than the FPTAS schemes (for small values of ∈) without sacrificing optimality even for moderate N (see FIG. 11). Moreover, the sequential FPTAS schemes are unable to exploit the parallelism the way one or more embodiments do.

Early HPC works investigated efficient all-to-all collective communication on well-known topologies, e.g., hypercubes, meshes, and tori. Johnsson and Ho proposed optimal all-to-all collectives for single-port and n-port models of hypercubes. Scott proposed optimal all-to-all collectives on meshes.

More recent works have studied all-to-all communication on topologies that have beneficial graph properties for supporting datacenter communications. The bisection bandwidth of a network (χ) is known to be related to all-to-all throughput in the sense that the latter is bounded from above by 4χ/N². Prior works have therefore used χ as a proxy for all-to-all throughput, and as a result, expander graphs received significant interest due to their low modularity and hence high χ. Routing all-to-all traffic along K-shortest paths on expander graphs with multi-path TCP congestion control yields good throughput in switch-based datacenter settings. The all-to-all problem has been formulated as an MCF in such contexts, and it has been shown that multiple expanders have nearly identical performance for all-to-all traffic. However, the present disclosure provides a first study that applies multiple forms of MCF constructs (link- and path-based) to optimize all-to-all collective communications on a diverse set of HPC and ML fabrics and topologies at scale.

Recently, an SMT-logic-based approach (SCCL) for synthesizing optimal collectives in a topology-agnostic manner for GPU fabrics has been proposed. However, this approach is computationally expensive due to the NP-hard nature of the SMT formulation. Follow-up work TACCL relies on integer programming and suffers from similar computational bottlenecks. Recently proposed TE-CCL improves upon TACCL's performance by combining multi-commodity flow with Mixed Integer Linear Programming (MILP) and A* search. These models focus on link-driven latency, which can be important at small sub-Megabyte buffer sizes. Formulations according to one or more embodiments of the present disclosure, on the other hand, maximize network utilization for all-to-all under large buffer sizes, and one or more embodiments observe that MCF solutions in general attempt to take short paths through the network anyway. An approach provided by the present disclosure is significantly more scalable, generating efficient schedules for 1K+ nodes in much less time than what TECCL reports it takes to solve all-to-all on 128 node networks.

### Multi-Commodity Flow-Based Algorithms

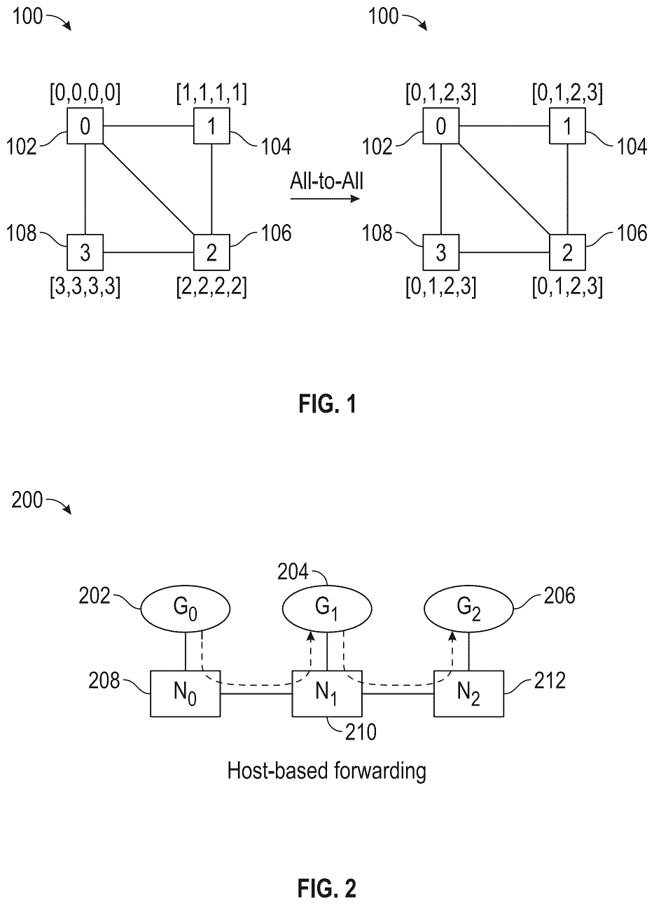

FIG. 1 illustrates a communication network 100 executing an all-to-all collective operation according to an example. An all-to-all collective operation is an operation where each node transmits data to each other node. The network 100 includes a first node 102, a second node 104, a third node 106, and a fourth node 108. The network 100 is illustrated in a first state prior to performing the all-to-all collective operation, and a second state after the all-to-all collective operation has been performed. The all-to-all collective operation may be performed over one or more timesteps.

In the first state, the first node 102 contains a vector of data comprising a plurality of 0 s, the second node 104 contains a vector of data comprising a plurality of 1 s, the third node 106 contains a vector of data comprising a plurality of 2 s, and the fourth node 108 contains a vector of data comprising a plurality of 3 s. Each node has also been assigned an index, with the first node 102 having an index of 0, the second node 104 having an index of 1, the third node 106 having an index of 2, and the fourth node 108 having an index of 3.

When the all-to-all collective operation is performed, each node propagates the contents of the data vector corresponding to each other node's index respectively to each other node. For example, the first node 102 transmits the 0th element of the data vector to whichever node has an index of 0 (in some examples, the first node 102 may have an index of 0), the first node 102 transmits the 1st element of the data vector to the second node 104 (the second node 104 may have an index of 1), the first node 102 transmits the 2nd element of the data vector to the third node 106 (the third node 106 may have an index of 2), and the first node 102 transmits the 3rd element of the data vector to the fourth node 108 (the fourth node 108 may have an index of 3). The other nodes behave in a similar manner, such that for a given node that node transmits the nth element of its respective data vector to the node having the nth index. In each case, the receiving node stores the received data in the index corresponding to the first node 102 (e.g., index 0 of that respective receiving node's data vector).

The second state illustrates the result of the above described operation. Each node now contains an identical data vector. That is, each of the first node 102, second node 104, third node 106, and fourth node 108 contain a data vector <0, 1, 2, 3>.

Note that the values at a given index of a given node in the first state may be anything, and need not be limited to the example provided. That is, the 0 s, 1 s, 2 s, and 3 s of the data vectors may be replaced with any value, vector, object, or other data. As a result, the vectors in each node need not be identical to one another.

Note that in a collective operation, like all-to-all, the amount of data flowing in the network can be quite large. The minimum amount of data flowing is equal, in this example, to the square of the number of nodes in the network. That is, for a network of N nodes there are N² data flows.

FIG. 2 depicts a host-based forwarding network topology 200 according to an example. The network 200 includes a first node 202, a second node 204, a third node 206, a first switching device 208 (“first switch 208), a second switching device 210 (“second switch 210”), and a third switching device 212 (“third switch 212”). The switching devices may be any kind of switching device suitable for a direct-connect network, for example, a network interface controller (“NIC”).

The first node 202 is coupled to the first switch 208. The second node 204 is coupled to the second switch 210. The third node 206 is coupled to the third switch 212. The second switch 210 is coupled to the first switch 208 and third switch 212.

The network 200 is configured using hop-to-hop routing. That is, the switches 208-212 do not support “wormholing” (e.g., direct forwarding) and thus must route data they receive to the node to which they are coupled before the data can be routed further on. For example, data sent from the first node 202 to the third node 206 must go to through the first switch 208 and second switch 210 to the second node 204 and then from the second node 204 through the second switch 210 and third switch 212 to the third node 206. That is, the second node 204 acts as an intermediary that receives the data (e.g., on the CPU or GPU of the second node 204) prior to the data continuing on to the third node 206.

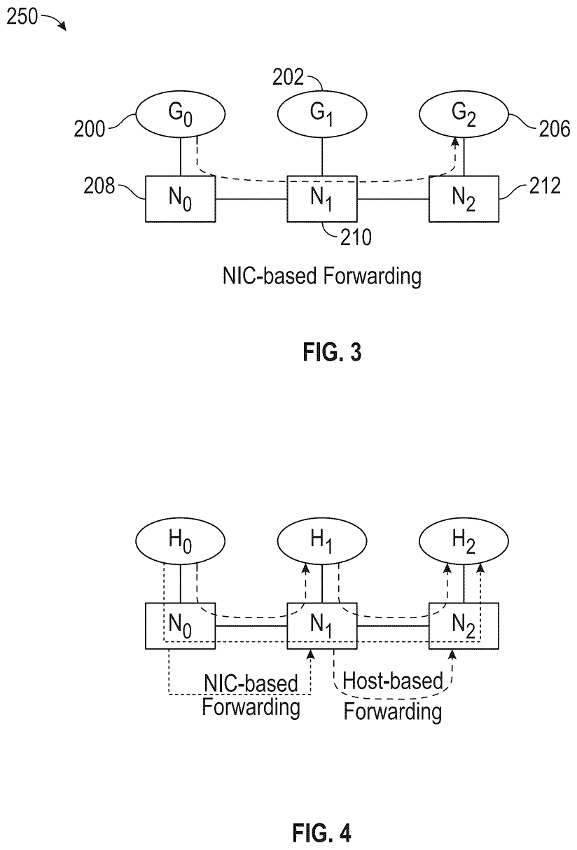

FIG. 3 illustrates an NIC-based forwarding network topology 250 according to an example. The network 250 is identical to the network 200 except that the switches 208-212 now support or have been configured to support “wormholing”, i.e., the network 200 is source-routed. In a wormholing configuration, the intermediary node can begin forwarding a packet before the packet is entirely received. Forwarding may begin as soon as the intermediary node knows the node to which it is forwarding the packet (which may be predetermined, or may be contained in header bits in the packet, such that the intermediary node need only receive the header bits before it begins forwarding). As a result, data originating with one node can be transmitted to another node without stopping at any intervening nodes. For example, if the first node 202 is transmitting data to the third node 206, the data may be transmitted from the first node 202 through the first switch 208, second switch 210, and third switch 212, and thence to the third node 206 in a continuous or semi-continuous manner.

Because forwarding can begin immediately or almost immediately (e.g., as soon as at least one bit of the packet is received), deadlocks may occur if the next node in line (e.g., another intermediary node or the destination node) does not have sufficient space in its buffer to hold the entire packet.

FIG. 4 compares a difference between a NIC-based forwarding network topology and a host-based forwarding of flow from host H₀ to H₂, and

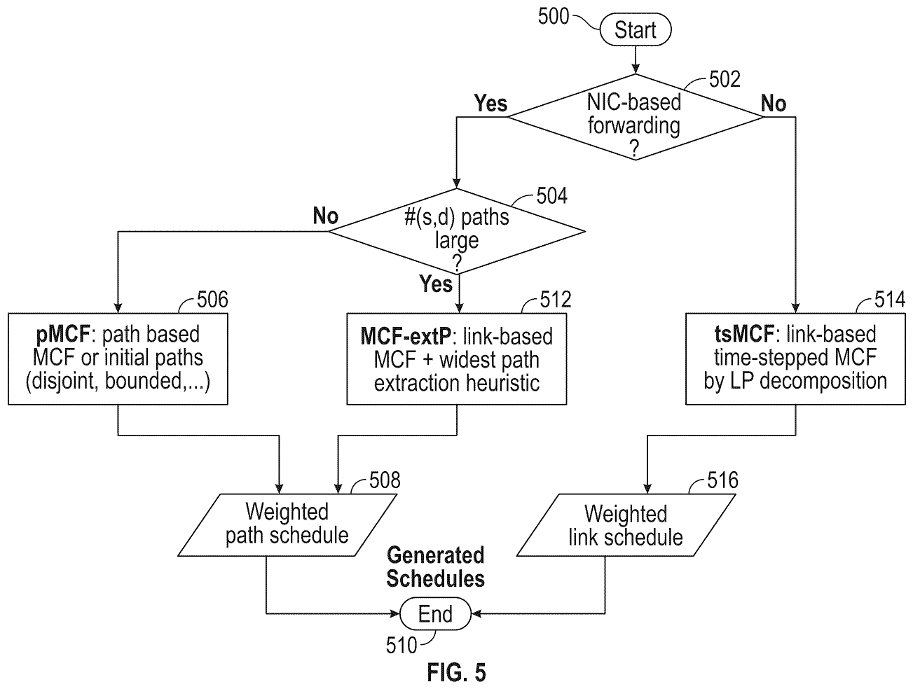

Turning now to FIG. 5, a flowchart illustrates the various algorithms employed for generating all-to-all schedules for direct-connect fabrics or a direct-connect communication network. The method begins at operation 500 and determination is made as to whether a NIC-based forwarding network topology is present at operation 502. When a NIC-based forwarding network topology is determined, a determination is made as to whether a large number of (s, d) paths exist at operation 504. In a non-limiting embodiment, a large number of (s, d) paths can be determined to exist when the number of (s, d) paths exceeds a threshold number of paths. When a large number of (s, d) paths does not exist, a pMCF is generated at operation 506. The pMCF is a path-based MCF generated according to initial paths (e.g., disjointed, bounded, etc.). Following the pMCF, a weighted path scale is generated at operation 508, and the method ends at operation 510.

When, however, a large number of (s, d) paths exists, a MCF-extP is generated at operation 512. The MCF-extP is link-based with a widest-path extraction heuristic. Following the pMCF, a weighted path scale is generated at operation 508, and the method ends at operation 510.

When a NIC-based forwarding network topology is not present at operation 502, a tsMCF is determined at operation 514. The tsMCF is a time-based time-stepped MCF by LP decomposition. Accordingly, a weighted link schedule is generated at operation at 516 and the method ends at operation 510.

As shown in FIG. 5, for ML-style fabrics with host/GPU-based forwarding, weighted link-based schedules are generated by solving the time-stepped version of the MCF problem. An MCF solution defines what chunks of data corresponding to a certain (s, d) pair (or commodity) should be transmitted by an intermediate node u over each of its outgoing links (u, v) at time step t. A naive solution involves solving a linear program (LP) on variables defined for each commodity, link, and time step-in the worst case, the total number of variables grows as N (N−1)×O(N)×O(N)=O(N⁴) where N is the network size (bounded degree networks have O(N) links and the number of time steps, lₘₐₓ≥the diameter, which can be O(N)). One or more embodiments propose to decompose this LP into a primary source-only LP that first computes aggregate optimal flow rates leaving each source s and then uses this solution to compute optimal flow rates for each (s, d) pair. This enables scaling to networks with thousands of nodes.

For HPC-style fabrics with NIC-based forwarding, one or more embodiments generate path-based schedules that constitute a set of paths P_{s,d} for each (s, d) pair and weights w(pᵢ) associated with each path pᵢ∈P_{s,d} controlling the fraction of traffic that should be sent along pᵢ. Optimal path-based schedules can be computed by solving the path-based version of the MCF, which is a natural dual of the link-based version mentioned earlier. However, this involves defining optimization variables for every possible (s, d) path, which is prohibitive for many topologies, even if one or more embodiments restrict the path set to include only shortest paths. One or more embodiments of the present disclosure use good heuristics like sampling good path sets of small cardinality (e.g., edge-disjoint paths) to mitigate this problem. One or more embodiments of the present disclosure also propose another radically different approach that instead solves the link-based MCF, and then applies an iterative “widest path” extraction algorithm to greedily extract high-flow (s, d) paths from the optimal per-link flows. Although potentially suboptimal, this approach is tractable and has good performance on the topologies one or more embodiments study.

For a given a network G=(V, E, cap:E→R+), where cap denotes link capacities, the problem of maximizing all-to-all throughput can be modeled as a maximum concurrent multi-commodity flow (MCF) problem with N (N−1) commodities of equal demand. This problem can be formulated using Linear Programming. One or more embodiments define variables f_{(s,d),(u,v)} to denote the amount of flow of commodity s→d that should traverse link (u, v) and concurrent demand variable F (i.e., the common rate at which all commodities will flow concurrently), and solve the LP below.

### Link-Based Max-Concurrent MCF Formulation:

| | |
|---|---|
| maximize F | (1) |
| $subject to : {\sum }_{s , d} {f}_{( s , d ) , ( u , v )} \leq {cap}_{( u , v )} , ∀ u , v$ | (2) |
| ${\sum }_{v} {f}_{( s , d ) ( u , v )} \leq {\sum }_{w} {f}_{( s , d ) , ( w , u )} , ∀ s , d , u : s \neq u , d \neq u$ | (3) |
| ${\sum }_{w} {f}_{( s , d ) , ( w , d )} \geq F , ∀ s , d$ | (4) |
| f_{(s,d),(u,v)} ≥ 0, ∀s, d, u, v | (5) |

The flow conservation constraint is modeled by inequality. This improves the speed of the LP solver; at the optimal solution, the inequality is enforced with no slack. Also, enforcing the demand constraint only at the sink node d is sufficient since the combined flow conservation and demand constraints at the sink enforce the same at the source. If however, a flow f_{(s,d)} with optimal F returned by the solver has extra flow near s (due to inequality), a post-processing step from d to s is executed to ensure exact flow conservation. An optimal flow generally follows links along multiple paths over the network. This LP is solvable in polynomial time, albeit in high-order polynomial time. To improve solver efficiency, one or more embodiments use a compact formulation of the LP in which all the flow conservation and demand constraints are expressed by a single matrix-vector constraint that relates the product of the node-to-link incidence matrix and link-flow vector to the per-commodity demand matrix scaled by F. This eliminates the “pre-solve” canonicalization step.

A key disadvantage of the per-commodity based LP approach is that the number of link-flow variables for a k-regular graph is kN² (N−1), which gets intractable even at modest scales (hundreds of nodes).

Since the MCF LP approaches discussed above are computationally challenging, one or more embodiments decompose the problem of computing the optimal flow for N (N−1) commodities by considering N groups of source-rooted flows (each delivered to N−1 destinations). Specifically, one or more embodiments follow the steps below.

Compute source-based grouped commodity flows: Solve a master LP, defined in, for computing the optimal concurrent rates for N source-rooted grouped multicommodity flows. The source-based flow conservation reflects the fact that the total amount of flow entering u has to be greater than the sum of the amount of flow leaving u and the amount sunk at u (which must equal the concurrent flow value F). Since one or more embodiments worry about only N groups of commodities (instead of N(N−1) point-to-point commodities), one or more embodiments only need kN² variables, which is tractable (thousands of nodes).

Compute optimal per-commodity flows: Once the per source optimal flow has been computed, solve N additional simpler Child LPs, one per source as defined in (10)-(14), to determine the flow values per link for each (s, d) commodity. Each such LP (say for source s) will set the link capacities to the flow values computed by the master LP, and will solve a standard maximum concurrent multicommodity flow (on a thusly capacity-adjusted graph) for N−1 commodities {s→v|v∈V\{s}}. These LPs can be run in parallel on multi-core processors, have kN (N−1) flow variables to optimize, and are generally simpler in complexity than the original LP. Solving N+1 LPs with O(N²) variables each is much more tractable than solving a single LP with O(N³) variables since the computation complexity of LP is generally much higher than linear in the number of variables.

### Decomposed Link-Based MCF (for Scalability):

Master LP to compute source-based grouped commodity flows:

| | |
|---|---|
| maximize F | (6) |
| $subject to : {\sum }_{s} {f}_{s , ( u , v )}^{′} \leq {cap}_{( u , v )} , ∀ u , v$ | (7) |
| $F + {\sum }_{v} {f}_{s , ( u , v )}^{′} \leq {\sum }_{w} {f}_{s , ( w , u )}^{′} , ∀ s , u : s \neq u$ | (8) |
| f_{s(u,v)}′ ≥ 0, ∀s, u, v | (9) |

Child LPs to extract link flows from source-based flows:

| | |
|---|---|
| $minimize {\sum }_{d , u , v} {f}_{( s , d ) , ( u , v )}$ | (10) |
| $subject to : {\sum }_{d} {f}_{( s , d ) , ( u , v )} \leq {f}_{s , ( u , v )}^{′} , ∀ u , v$ | (11) |
| ${\sum }_{v} {f}_{( s , d ) , ( u , v )} \leq {\sum }_{w} {f}_{( s , d ) , ( w , u )} , ∀ d , u : s \neq u , d \neq u$ | (12) |
| ${\sum }_{w} {f}_{( s , d ) , ( w , d )} \geq F , ∀ d$ | (13) |
| f_{(s,d),(u,v)} ≥ 0, ∀s, d, u, v | (14) |

The decomposed LP approach yields the optimal MCF value F as the standard approach although the actual flow values f returned may be different.

MCF formulation may yield rates at which each commodity should be transmitted by considering the flow of data to mimic that of infinitesimally divisible fluids. However, this is inadequate for ML network fabrics where accelerators send finite data chunks in a finite number of fixed-length time steps. This necessitates the generation of time-stepped schedules. To this end, one or more embodiments of the present disclosure extends the notion of MCF to the temporal domain by computing flows on a time-expanded stacked graph representation of G. It has lₘₐₓ₊₁ time-indexed instances uₜ of each node u∈G and directed edges uₜ→vₜ₊₁ with cap=1 whenever (u, v)∈G as well as “self” edges uₜ→uₜ₊₁ with cap=∞ denoting potential buffering at u over time. lₘₐₓ is set to a value≥diameter (G). One or more embodiments compute flows on this time-expanded graph essentially following the procedures described herein. The main difference is in the size of the input graph. In this case, it has (lₘₐₓ+1)|V| nodes and lₘₐₓ(|V|+|E|) links, and hence the LPs take somewhat longer to solve. However, the time-expanded graphs are directed acyclic graphs and are hence less complex. This tends to help mitigate the running time issues of the LPs. Another key difference is that all nodes do not source/sink traffic; instead, the nodes u₀ source traffic for nodes vₗₘₐₓ₊₁ and non-zero flow along an infinite capacity “self” edge essentially simulates waiting for a time slot. The equivalent time-stepped LP formulation is given below.

tsMCF: For ML Fabrics with Host/GPU, Forwarding

| | |
|---|---|
| $minimize {\sum }_{t} {U}_{t}$ | (15) |
| $subject to : {\sum }_{s , d} {f}_{( s , d ) , ( u , v ) , t} \leq {U}_{t} , ∀ u , v , t$ | (16) |
| ${\sum }_{{t}^{′} \leq t , v} {f}_{( s , d ) , ( u , v ) , {t}^{′}} \leq {\sum }_{{t}^{″} < t , w} {f}_{( s , d ) , ( w , u ) , {t}^{″}} ,$ | (17) |
| ∀s, d, u, t:s ≠ u, d ≠ u, t >1 | |
| ${\sum }_{{t}^{′} , v} {f}_{( s , d ) , ( u , v ) , {t}^{′}} = {\sum }_{{t}^{″} < t , w} {f}_{( s , d ) , ( w , u ) , {t}^{″}} , ∀ s , d$ | (18) |
| ${\sum }_{{t}^{′} , v} {f}_{( s , d ) , ( s , v ) , {t}^{′}} = {\sum }_{{t}^{″} , w} {f}_{( s , d ) , ( w , d ) , {t}^{″}} = 1 , ∀ s , d$ | (19) |
| 0 ≤ f_{(s,d),(u,v),t} ≤ 1, ∀s, d, u, v | (20) |

The objective (15) minimizes the utilization of bandwidth at every time step, while the constraint (16) ensures that the total utilization at every edge is less than the bandwidth. The constraint (17) enforces the amount of data received by node u must be greater than or equal to the amount of data sent by node u from comm step 1 to every other comm step (the difference is reserved for future send). Constraint (18) enforces the total amount received by node u is equal to the total amount sent by node u. Constraint (19) enforces that the total amount sent by the source and received by the destination is equal to 1. One can add a multiplier to f_{(s,d),(u,v),t} in the first constraint if link bandwidth is not uniform among all links. This time-stepped LP can be decomposed into a source-based LP+child LPs.

In networks supporting multi-hop routing, one or more embodiments need to compute the optimal rates of flows along multiple paths from each source s to each target node d. One or more embodiments first compute a set of paths “P” for each commodity/(s, d) pair. Next, for each path p∈P and (s, d) pair, define flow variable f_{(s,d),p}∈R+∪{0}.

As in the link-based formulation, one or more embodiments ensure that the link capacity constraints are obeyed at each link. The flow conservation constraints are automatically obeyed at each node since data will be flowing along simple paths (in-degree and out-degree are 1). The LP formulation is shown in (21)-(24).

If the set of paths “P” is allowed to consist of all paths of unbounded length, then path-based MCF is a natural dual of link-based MCF and hence provides the same optimal MCF value. However, solving such a dual problem is impractical since |P| typically grows exponentially with N. One or more embodiments make the path-based MCF in practical scenarios tractable by curtailing the number of paths in the set “P” to O(poly(N)). Restricting the path lengths to below lₘₐₓ drastically reduces |P|. This approach works for many networks of interest (per empirical observation), e.g., expander graphs like generalized Kautz graphs, where |P| is polynomial in N, lₘₐₓ. However, in several other graphs that possess a high degree of symmetry, e.g., torus graphs, the number of paths of length lₘₐₓ grows exponentially in lmax since the diameter is √N; therefore:

$$\vert 𝒫 \vert \geq \frac{1}{\sqrt{N} + 1} ( \begin{matrix}2 \sqrt{N} \\ \sqrt{N}\end{matrix} ) .$$

which grows super-exponentially in N. Therefore, this makes the approach intractable for large tori. One tractable heuristic capable of achieving the optimal MCF solution is to choose P to be a maximal set of link-disjoint (s, d) paths, which can be found efficiently and whose cardinality is upper bounded by k_{N(N-1)} for k-regular graphs.
pMCF: For Fabrics with NIC Forwarding

| | |
|---|---|
| maximize F | (21) |
| $subject to : {\sum }_{s , d} {\sum }_{p ∋ \text{?}} {f}_{( s , d ) , p} \leq {cap}_{e} , ∀ e ∈ E$ | (22) |
| ${\sum }_{p ∋ 𝒫 \text{?}} {f}_{( s , d ) , p} \geq F , ∀ s , d$ | (23) |
| f(s,d), p ≥ 0, ∀s, d, u, v | (24) |

$\text{?} \text{indicates text missing or illegible when filed}$

The paths along which each commodity (or in some instances certain fractions thereof) would flow must be provided at the respective sources of the commodity. One or more embodiments propose two different approaches below based on whether a topology has low or high path diversity(1) pMCF: Directly applying path-variable based MCF (low path diversity); and (2) MCF-extP: Applying link-based MCF and extracting paths (high path diversity). For pMCF, the path-variable based MCF formulation described in (21)-(24) can be applied to source-routed fabrics for graphs in which the path diversity does not grow exponentially in N, as is the case with expander graphs. However, this approach is not tractable for graphs like the multi-dimensional torus where the number of paths (with length≤lₘₐₓ) grows super-exponentially in N.

For MCF-extP, one or more embodiments first solve the decomposed link-based MCF described above. However, for source-routed fabrics, one or more embodiments need to obtain the paths on which the different commodities should flow. Therefore, as a final step, paths can be extracted from the link-based MCF solution. Given the MCF flow values on each link corresponding to each (s, d) commodity, one or more embodiments construct a weighted subgraph DAG G_{s,d} of the original graph G induced by the edges with non-zero (s, d) flow (weights=MCF flows). One or more embodiments then iteratively extract (s, d) paths from G_{s,d} by greedily solving the widest path problem, by making minor modifications to Dijkstra's shortest path algorithm:
1. Find (s, d) path p in G_{s,d} with maximum flow rate (r);
2. Subtract r from the capacities of all the links in p;
3. Repeat the two previous steps until s no longer has a non-zero capacity path to d; and
4. Upon termination, the algorithm finds a set of (s, d) paths with decreasing flow rates, which are ready for lowering.

As described above, different all-to-all scheduling approaches for source routed fabrics are provided. Relevant math formulations are linked in the descriptions through equation and section references. This also describes when path-based MCF (pMCF) cannot be used, i.e., when there are an exponential number of s-d paths. One or more embodiments then have to use link-based MCF with subsequent approximately optimal path-extraction (MCF-extP). These approaches are applicable where there is extra forwarding bandwidth available at the NIC-NIC level, so a NIC can actually use some of its extra capacity to forward data that is not intended for its attached host (CPU or GPU).

When forwarding and flow control are performed by the host/GPU (no hardware routing), one or more embodiments use the time-stepped link-based MCF formulation described herein to obtain chunk schedules that exactly specify what data needs to be sent (or received) by each GPU at every time step.

In scenarios where the host-to-NIC bandwidth Bₕₒₛₜ is less than the net egress/ingress link bandwidth at the NIC, i.e., Bₕₒₛₜ<d·b, the host-to-NIC bandwidth becomes a bottleneck. FIG. 2, for example, shows how to augment the original NIC topology to model this host-to-NIC bottleneck. One or more embodiments augment the graph in a manner that forces data to flow through the host even when the node is not the destination. The MCF computed between the host nodes on the augmented graph yields the optimal throughput. One or more embodiments applies a time-stepped link based MCF (tsMCF) formulation to generate schedules.

One or more embodiments implement compilers and interpreters to lower the schedules and paths, and execute them on CPU and GPU runtimes. Link-based Schedules, for example, utilize a link-based MCF algorithm. The link-based MCF algorithm produces schedules that are chunked and lowered to both Microsoft's MSCCL and Intel's oneCCL. MSCCL is an open-source collective communication library that extends NCCL and RCCL with an interpreter providing the ability to program custom collectives on GPUs. Collective schedules are defined in XML as instructions (send/receive/reduce/copy) within GPU thread blocks that the interpreter executes. One or more embodiments additionally lower the same schedules to oneCCL+libfabric, an open-source collective communications library by Intel that supports CPUs.

One or more embodiments extended oneCCL with an interpreter, in a similar way that MSCCL extended NCCL, that executes the XMLs. The oneCCL XMLs similarly specify instructions (send, receive, reduce, copy, sync) and add scratch buffers for chunk forwarding. The primary challenge in creating both MSCCL and oneCCL schedules was chunking. The MCF solution produces the fractional rates f_{(s,d),(u,v),t} for each commodity (s, d) on each link (u, v) at each time step t. The lowering algorithm determines the smallest chunk size to support the lowest such rate, which guides how granularly a shard is chunked and how chunks are combined and forwarded by intermediate ranks. At each time step, a rank then sends the total outgoing flow (the chunks received in the previous time step), receives the total incoming flow (chunks to receive in the current time step), and performs synchronization. In both MSCCL and oneCCL, one or more embodiments have the ability to increase the number of channels by duplicating the schedule and running a parallel copy on different threads. All sends and receives are asynchronous with no data dependencies. As described above, practical steps are provided that allow for lowering the time-stepped MCF schedules on ML fabrics.

As described above, the weighted path-based MCF algorithm produces a set of weighted paths for each commodity (shard) B_{i,j}(source i, dest j). Weighted multi-path routing and flow control should ideally be performed by the hardware, to which one or more embodiments would lower the MCF schedules (the per-commodity routes and weights). In example testbeds, one or more embodiments use the Cerio (Rockport) NC1225 network card. While the current version of the Cerio card natively supports multi-path routing on user-specified routes, it does not expose the capability to program the weights per route. This means one or more embodiments cannot directly use the native multi-path capability, which one or more embodiments disable. One or more embodiments instead approximate the weighted paths MCF by: (1) lowering the routes for each commodity B_{i,j} to the underlying fabric, (2) dividing each shard/commodity into a set of equal-sized chunks, and (3) steering chunks onto routes as defined in a testing schedule.

Specifically, the Cerio card exposes a utility for lowering computed source routes to the hardware, where a route specifies the egress ports on the traversed links from source to destination as well as the layer identifier for the route; the layer identifier is used to assign routes to different virtual channels in order to eliminate deadlocks. The card also allows us to steer flows to routes at the application layer. This is possible in ROCE v2 by setting the UDP source port when creating the RDMA Queue Pair (QP), such that the tuple (src port, src IP, dst IP, QP number) hashes to the desired route id. One or more embodiments implemented the scheduling and flow steering functionality in Open MPI+UCX. The chunked schedule specification is lowered to an XML that is executed by the interpreter. The latter is implemented in OMPI as part of the tuned collectives component within the Modular Component Architecture (MCA). The schedule defines the chunks and path each should take, and the extended OMPI+UCX runtime creates the correct number of Queue Pairs (QPs) and performs the steering. A shard is divided into a set of equal-sized chunks as follows: one or more embodiments compute the highest common factor across all path weights in the MCF solution and use that as the base chunk size (call it c). Each shard of size “m” bytes is then divided into ┌m/c┐ chunks, and the correct number of chunks is assigned to each path based on the path weight. This approach ensures all chunks (flows) fairly share the bandwidth, approximating the ideal MCF in practice on the Cerio fabric. As described above, the practical steps in lowering of path-based MCF schedules on HPC clusters equipped with optical NICs with extra forwarding bandwidth. The TACC testbed is an example of an HPC testbed.

One or more embodiments evaluate schedule performance and algorithm runtime at increasing scales on different hardware and on different direct-connect optical topologies. One or more embodiments also present performance results at a large scale in simulation. One or more embodiments summarize various performance results provided by embodiments of the present disclosure.

One or more non-limiting embodiments provides lowered tsMCF schedules deliver near-optimal throughput performance on different topologies and scales, outperforming state-of-the-art baselines by up to 1.6 times, or greater.

One or more non-limiting embodiments also provide lowered MCF-extP and pMCF schedules, which deliver near-optimal throughput performance on different standard and non-standard topologies and scales, outperforming state-of-the-art scalable baselines by up to 30%, and the all-to-all speedups directly translate to speedups in the 3D FFT workload. MCF outperforms other scalable baselines at large scale in simulation.

Through large-scale simulations going up to 1000 nodes, one or more non-limiting embodiments provides a MCF decomposition approach, which yields orders of magnitude improvement in algorithm runtime over the original MCF and all other baseline schedule generation approaches.

One or more embodiments identify GenKautz as a family of expander topologies that have near-optimal all-to-all performance while also having complete coverage in N and d, outperforming other well-known expander topologies.

### Direct-Connect Testbed and Cluster

One or more embodiments evaluate the all-to-all schedules on two testbeds: an internal 8 server (1 NVIDIA A100 GPU per server) testbed that supports topology reconfiguration, and an external 27 server (1 CPU per server) cluster at the Texas Advanced Computing Center (TACC) where topology is fixed to the Torus. Cerio Card. In both testbeds, each server is equipped with a Cerio NC1225 network card. The card supports source routing with multi-path and cut-through flow control, and stores up to 8 routes per destination. It offers up to 300 gigabytes per second (GBps) of total forwarding bandwidth using 12× 25 GBps links (b=25 Gbps or 3.125 GB/s), and supports 100 GBps of injection bandwidth from the host or GPU using x16 PCIe gen3. One or more embodiments can accordingly evaluate both link and path-based schedules on both testbeds.

Internal GPU Testbed. The network cards are directly connected via a Telescent optical patch panel. The testbed can realize different topologies by reconfiguring the patch panel. One or more embodiments limit the evaluation to bidirectional topologies, specifically hypercube and twisted hypercube both with degree 3 (i.e., B=75 Gbps), and complete bipartite with degree 4 (B=100 Gbps). While unidirectional topologies (e.g., GenKautz) can be realized by configuring the patch panel in simplex mode, one or more embodiments cannot accurately evaluate their performance since the requisite overlay routing for the reverse path traffic (acks) is currently only supported using routing rules performed by the kernel leading to unpredictable RTTs.

A cluster of CPU servers at TACC are connected in a fixed torus topology using the Cerio fabric. One or more embodiments use a 3×3×3 torus (27 nodes, degree=6) from the cluster. The host injection bandwidth of 100 Gbps is less than B=150 Gbps for degree 6; hence, the benefits of path based schedules can be evaluated to exploit the extra forwarding bandwidth for all-to-all.

### Evaluation of Optimized Collectives

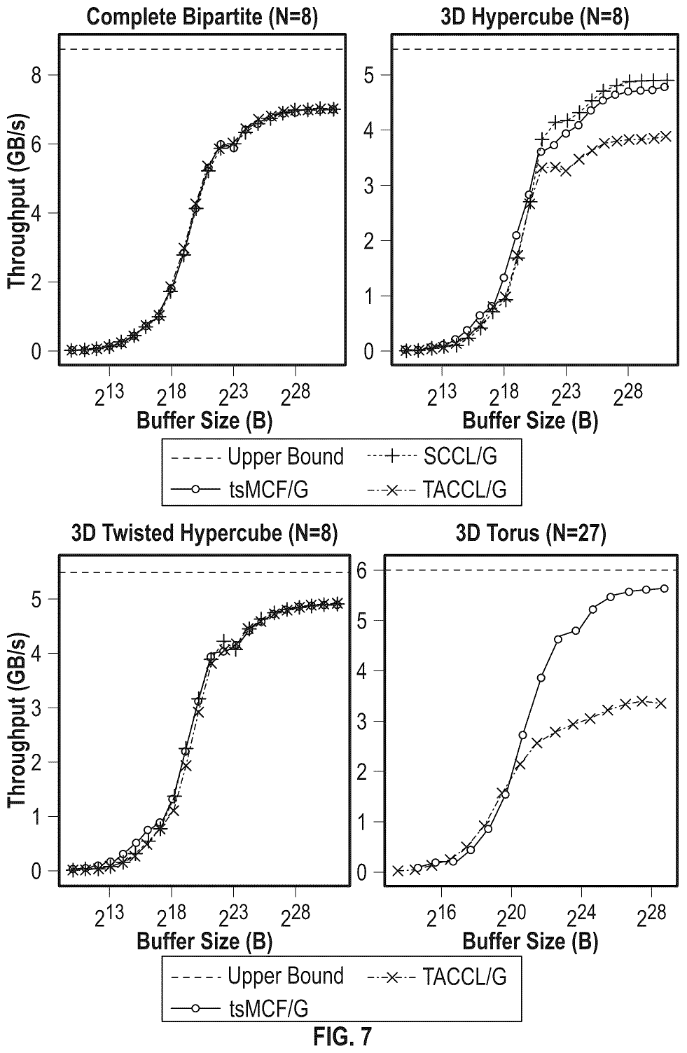

FIG. 7 shows lowered link-based tsMCF schedules deliver near-optimal performance at large message sizes on different topologies and scales according to one or more non-limiting embodiments provides. State-of-the-art scheduling algorithms such as SCCL do not scale, failing to terminate even at a modest 27-node scale (see FIG. 7). TACCL schedules, on the other hand, underperform on the Hypercube by 22% and on the 3D Torus by up to 1.6× at large buffer sizes (see FIG. 7). Since the GPU testbed is constrained to an 8-node scale, one or more embodiments resort to the CPU cluster to evaluate at larger 27-node scale. In FIG. 7, the algorithm name is appended with /C to indicate a reduction to one CCL and ran on CPUs, whereas /G refers to lowering to MSCCL and running on the A100 GPUs. Recall the link-based schedule experiments in FIG. 7 do not use the routing capability from the underlying fabric; all transfers are on point-to-point links controlled by the scheduling thread(s) on the host GPU or CPU.

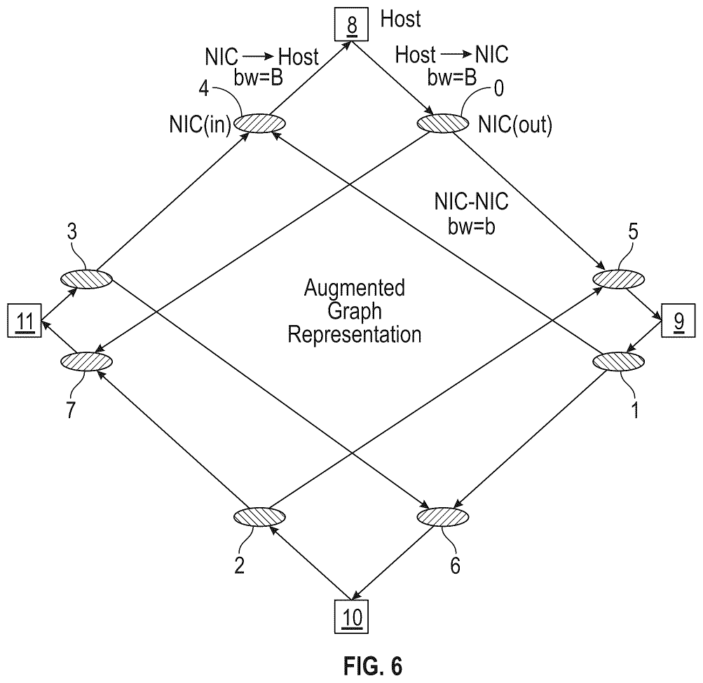

As shown in FIG. 7, for example, the 3D Torus, tsMCF can utilize the bottleneck model (see FIG. 6) to produce the schedule since the host injection bandwidth (100 Gbps) is lower than the NIC bandwidth (150 Gbps for degree 6). The flow value produced by MCF on this bottlenecked 3D Torus topology is f=2/27, which dictates the theoretical upper bound of (N−1)fb=(26)*(2/27)*3.125)=6.01 GB/s. On the other hand, the flow value in the non-bottlenecked setting, which is 57% higher. The theoretical upper bound on throughput is (N−1)fb, where f is the optimal flow value given by MCF (each commodity gets a max flow value of f assuming link capacity is 1, so when link capacity is b, the max achievable flow out of a node sourcing N−1 flows is (N−1)fb).

In summary, one or more non-limiting embodiments show that the optimized tsMCF schedules are ideal for both GPU and HPC fabrics where additional forwarding bandwidth is not available while being generalizable to a wide range of topologies. Path-based schedules utilizing forwarding bandwidth. One or more embodiments also implement two link-load-minimizing single-path baselines. The first is based on Integer Linear Programming (ILP) which is tractable only at small scales. It selects a subset of a candidate set of (s, t) paths such that the maximum load on any link is minimized. Low maximum load leads to high all-to-all throughput. Embodiments described here can also use both link-disjoint (ILP-disjoint) and shortest paths (ILP-shortest) in the candidate set. The second baseline is Single Source Shortest Path (SSSP) heuristic that iteratively computes shortest paths through a graph whose link weights reflect the additional congestion caused due to each iteration.

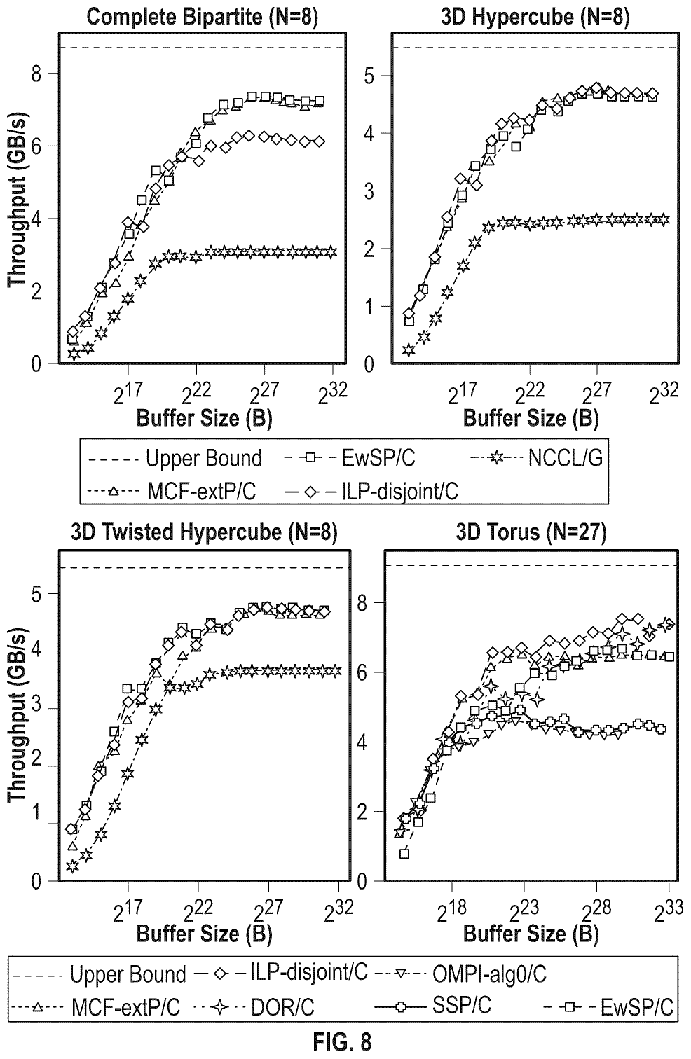

FIG. 8 show that lowered MCF-extP schedules deliver near optimal bandwidth performance in practice as one or more embodiments see at small scale (N=8) for the complete bipartite topology, and both the hypercube and twisted hypercube topologies. On the complete bipartite, one or more embodiments see MCF-extP outperforms ILP-disjoint, which matches the theoretical results since the latter, which is constrained to a single path per commodity, is not bandwidth optimal on this topology. On the 27 node 3D Torus on the supercomputer, a MCF-extP slightly underperforms due to practical limitations with injection rate control in the current fabric. Both dimension ordered routing (DOR) and ILP-disjoint are theoretically bandwidth optimal on the 3D Torus and are strong baselines. However, DOR does not work on non-Tori topologies, and ILP-disjoint does not produce optimal solutions in general and becomes intractable for larger topologies. SSSP is both scalable and general, but it produces sub-optimal solutions and is more than 50% worse than MCF-extP on the 3D Torus at large buffers.

MCF-extP also far outperforms NCCL and OMPI native all-to-all algorithms up to 2.3 times on Bipartite, and 55% on 3D Torus. NCCL/OMPI native schedules perform N−1 point-to-point send/recv operations (flows) per rank. These flows utilize the deadlock-free routes underneath which are computed by the Cerio fabric. One or more embodiments also implement and evaluate the Equal weight Shortest Path (EwSP) baseline that distributes each commodity equally on all the shortest paths between source and destination. While EwSP performs very well on all the four topologies in FIG. 8, this is not the case in general.

Comparing path-based schedules of FIG. 8 to link-based schedules of FIG. 7 on the same topologies, one or more embodiments see that the bandwidth performance of MCF-extP is comparable to that of tsMCF at large buffer sizes for the Bipartite (degree=4), HyperCube and Twisted Hypercube (degree=3). This is expected on these low-degree topologies since there is no additional forwarding bandwidth that path-based MCF can exploit, and both approaches have the same theoretical upper bound. On the other hand, MCF-extP significantly outperforms tsMCF on the larger 27 node 3D Torus (by about 3.4× at 1 MB, and 15% at larger buffers) since it is able to exploit the additional forwarding bandwidth in this case (degree=6, B=150 Gbps≥100 Gbps injection bandwidth)—here MCF-extP is unable to reach its theoretical expected performance due to practical limitations on the current fabric. In general, MCF-extP provides a significant performance advantage at smaller buffers due to the superior latency performance of cut-through routing as compared to having to incur a global synchronization per timestep with tsMCF.

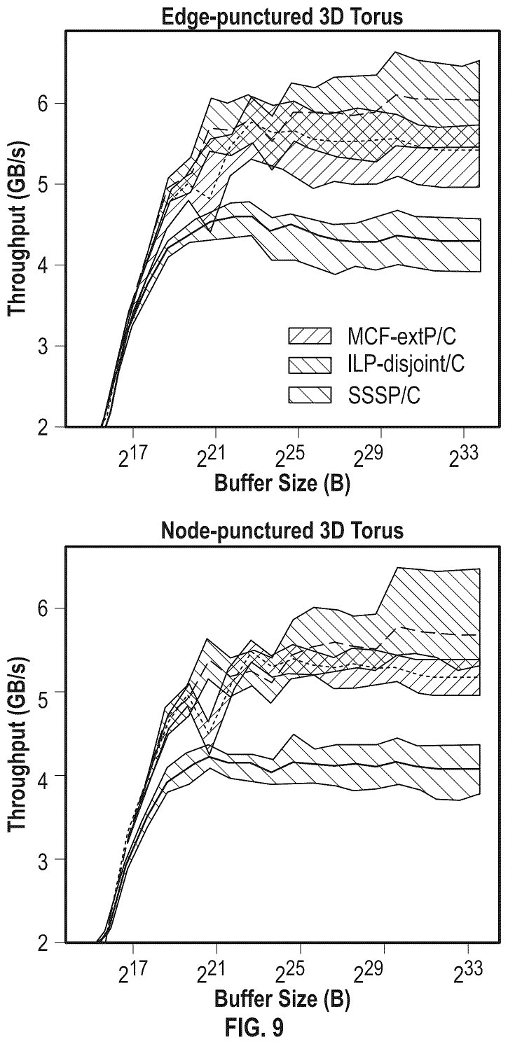

One or more embodiments assess the topology-agnostic quality of MCF-extP on heterogeneous degree topologies produced by sampling sub-graphs from the 3D Torus. Specifically, one or more embodiments sample 10 different instances of the 3D Torus to create edge-punctured (3 random edges removed) and node-punctured (3 random nodes removed) Tori. Baselines such as DOR are not defined for such punctured Tori. FIG. 9 shows the throughput of MCF-extP compared to ILP-disjoint and SSSP. The results are consistent with those of FIG. 8, where MCF-extP significantly outperforms SSSP but underperforms ILP-disjoint due to practical limitations with injection rate control. The results also match the empirical results, where one or more embodiments observe similar maximum link load for both ILP-disjoint and MCF (which is ˜30% lower than SSSP). Puncturing the Torus is a way to emulate failures of links and/or nodes, which would be expected in a cloud setting, and to show the superior performance of MCF in such scenarios. When combined with the superior algorithm runtime (see FIG. 11), e.g., run with 1000 node all-to-all in 40 minutes, this shows that the approach according one or more non-limiting embodiments is able to more quickly react to failures in networks of hundreds of nodes without compromising on performance.

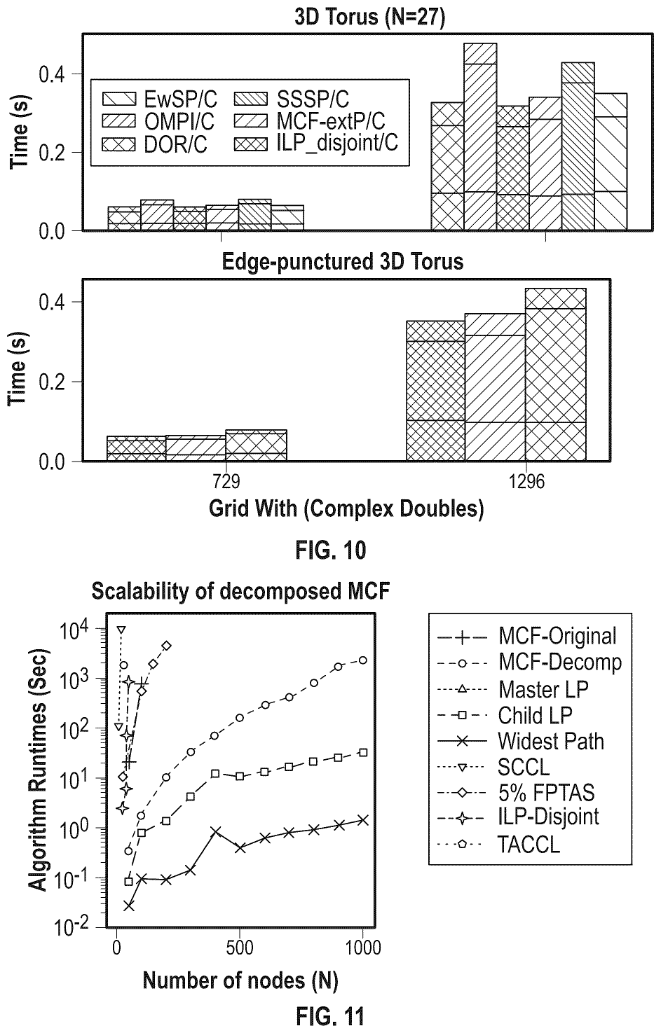

One or more embodiments implement distributed 3D Fast Fourier Transform (FFT), and run it on the 27 node 3D Torus, and on the edge-punctured 3D Torus on up to 12,963 grid size, corresponding to all-to-all buffer size up to 1.29 GB. FIG. 10 shows the speedups in the 3D FFT on the 3D Torus, e.g., as shown corresponding to all-to-all speedups from FIG. 8, and the punctured 3D Torus as shown corresponding to all-to-all speedups from FIG. 9. One or more embodiments observe up to 20% (14.9%) total speedup in the FFT time using MCF schedules according of the present disclosure compared to SSSP schedules on the 3D Torus (e.g., edge-punctured 3D Torus). The speedups are a direct result of the faster all-to-all MCF schedules, consistent with FIG. 8 and FIG. 9. One or more embodiments use the latest version of the FFTW library with multi-threading and with OMPI running all-to-all schedules of the present disclosure. One or more embodiments use slab decomposition, where each process (1 multi-threaded process per node) performs three steps: first computes 2D FFTs on its slabs and packs the data, then runs all-to-all with all other processes, and finally unpacks and computes 1D FFTs to complete the 3D FFT. These three steps involved in the FFT computation are shown with bands in the bars of FIG. 10 with the first step corresponding to the bottom band.

FIG. 11 shows that the MCF decomposition approach (MCF-decomp) according to embodiments of the present disclosure yields orders of magnitude improvement in algorithm runtime over the original MCF (MCF-original), and the other highly unscalable topology-agnostic schedule generation approaches such as SCCL, TACCL, Karakostas' Fully Polynomial Time Approximation Scheme (FPTAS), and ILP-disjoint. One or more embodiments show the computation time required for MCF-original (link-based) on N³ variables and MCF-decomp on N² variables for the generalized Kautz graph for various choices of N. One or more embodiments observe that even at the scales of N=50, 100, MCF-decomp is two orders of magnitude faster, while MCF-original fails to produce a solution for N>100 nodes in a reasonable time. In contrast, SCCL is unable to generate all-to-all schedules for N=16 even in 104 seconds. TACCL, a heuristic designed to be more scalable than SCCL, takes over 30 minutes to generate all-to-all schedules for even 32-node networks. Furthermore, for slightly larger networks, it is unable to produce even an approximate solution in 30 minutes. Even ILP-disjoint is only able to generate optimal schedules up to N=44. While one or more embodiments evaluate on the GenKautz topology in FIG. 11, the scaling trends apply to other topologies (expanders, tori) as well.

The algorithm runtime of MCF-decomp follows a polynomial trend, and it is dominated by the time taken to solve the “Master LP”, which is a source-based MCF leading to a solution in 40 minutes for N=1000 provided all “Child LPs” and subsequent “Widest path” extraction functions are run in parallel on N cores. The exact degree of the polynomial governing the speedup factor over original MCF is determined by that of the polynomial that determines the time complexity of solving such network flow LP problems. For example, if a state-of-the-art LP solver takes O(N^{2.37}) time to solve N-variable problems, the speedup factor can be estimated to be O(N^{3×2.37}/N^{2×2.37})=O(N^{2.37}).

FIG. 11 also shows the runtime performance of a state-of-the-art FPTAS by Karakostas at ∈=0.05. While it shows a polynomial scaling trend unlike the other baseline schemes mentioned earlier, it significantly underperforms the MCF (decomposed) algorithm in running time even after sacrificing optimality, thus making it impractical for networks larger than a couple of hundred nodes. The FPTAS, being an inherently sequential algorithm, cannot exploit the high degree of parallelism that is exploited by decomposed MCF.

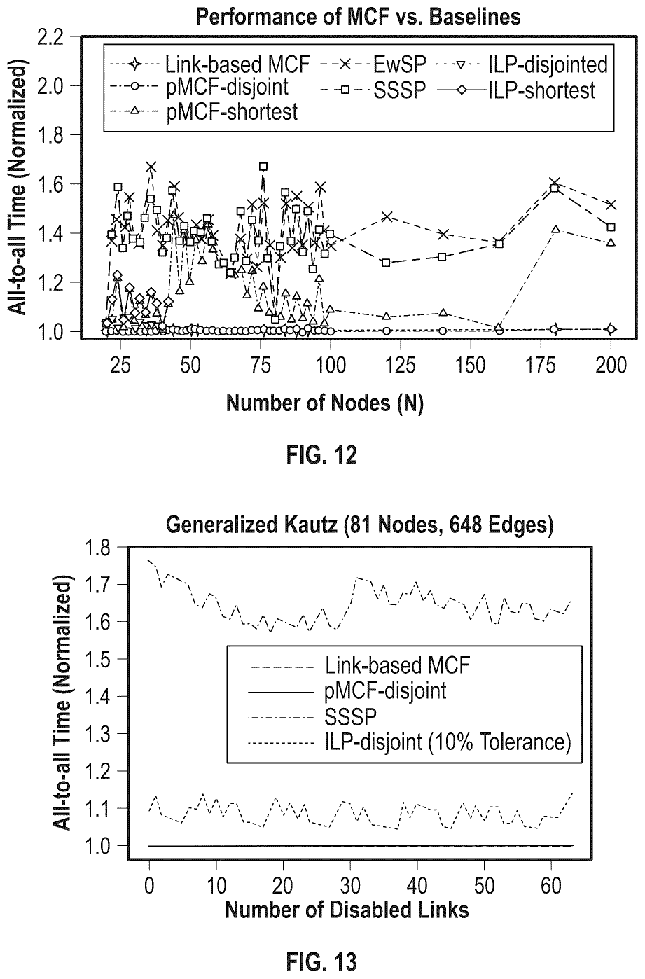

FIG. 12 a show the all-to-all time (the time to concurrently transmit the workload assuming unit commodity demand and link capacities; it is equal to 1/MCF and the maximum link load) of various path-based schemes normalized by optimal link-based MCF. Comparing single path schemes, mainly ILP and SSSP, although SSSP is fast, it is up to 1.6 times worse than the theoretically optimal MCF solution. On the other hand, the ILP schemes, although performant, do not scale well (see FIG. 11).

Although multipath schemes exploit the path diversity of the network well, naive multipath approaches such as Equal Weight Shortest Path that distribute the workload evenly along all available (s, t) shortest paths do not perform well. Its performance is similar to that of SSSP. However, weighted multipath schemes such as pMCF (Path-based MCF (disjoint)) and MCF-extP (Link-based MCF with path extraction) can achieve optimal or near-optimal performance. pMCF is optimal in theory if the number of (s, t) paths in the initial set is not restricted. However, this set can be extremely large, thus necessitating the development of decomposed MCF-extP, whose scalability has been illustrated in FIG. 11. However, in practice, if the (s, t) path set is restricted to link-disjoint paths, pMCF can almost match the optimal performance of pure link-based MCF. In addition, pMCF run with all shortest (s, t) paths exhibits suboptimal performance, especially for expander graphs (see FIG. 8) since the latter do not have too many shortest paths. While pMCF (with shortest paths) performs well on topologies such as tori, the starting path set is often exponentially large in size, thus making the scheme impractical. In contrast, link-disjoint (s, t) paths can be computed in polynomial time for arbitrary topologies. Since there are at most d disjoint paths for any (s, t) pair, the number of LP variables is O(N²), making it comparable to decomposed Link-based MCF in terms of time complexity.

FIG. 13 illustrates the generality and good performance of MCF schemes (when compared to baselines like SSSP) since they perform optimally/near-optimally on heterogeneous degree-irregular subgraphs, e.g., formed by disabling random links. At the N=81 scale considered (d=8), interestingly, ILP-disjoint shows performance close to link-based MCFs if set to a tolerance factor (∈=0.1); but it does not scale to large N owing to it being NP-hard.

Near Throughput-Optimal all-to-all Topologies

One or more non-limiting embodiments determine which topologies with N nodes and degree d yield the best all-to-all performance. For example, one or more non-limiting embodiments derive an upper bound for all-to-all throughput (equivalently, lower bound the all-to-all collective time) for arbitrary d-regular graphs with N nodes, and then highlight an expander graph that achieves performance close to this bound.

Theorem 1 (Lower bound on all-to-all time.). The time taken to accomplish all-to-all communication in a d-regular graph G on N nodes scales as Ω(N log_{d}N).

First, consider a single source node r and an arborescence (outgoing rooted directed tree) of G (denoted by T_{d,N}), which has N nodes and maximum out-degree d. It has d^{k} number of nodes at all levels k except when k is equal to its height. If r needs to send N−1 flows of value f to each of the other N−1 nodes along T_{d,N}, the minimum capacity needed is f×Σ_{u∈V,T_d,N} D(r,u), where D(s, t) is the distance (hop count) between s and t along T_{d,N}. Thus, the minimum capacity needed for sending commodities from all nodes (along N respective rooted arborescences) is N×f×Σ_{uΣVTd,N} D(r,u). Assuming that a d-regular di-graph has d outgoing unit capacity links per node, the total capacity available in the network is d×N. It follows that f×Σ_{u∈VT_d,N}, D(r,u)≤d. The all-to-all workload completion time/latency is given by:

$$1 / f \geq {\sum }_{u ∈ {V}_{{T}_{d , N}}} D ( r , u ) / d . \qquad ( 25 )$$

Also, in a d-regular graph where each arborescence is a full k layer tree,

$$N = {\sum }_{i = 0}^{k - 1} {d}^{i} = \frac{{d}^{k} - 1}{d - 1} and {{\sum }_{u ∈ {V}_{{r}_{d , N}}}}_{} D ( r , u ) = {\sum }_{i = 0}^{k - 1} i + {d}^{i} = \frac{{d}^{k + 1} ( k - 1 ) - {d}^{k} k + d}{{( d - 1 )}^{2}} = Θ ( k {d}^{k - 1} ) .$$

The RHS of Eq. (25) then becomes Θ(kd^{k-2})=Θ(N log_{d} N). This establishes the scaling law for the lower bound on all-to-all time in any d-regular N-node topology.

As described herein, a direct-connect communication network can be defined as having a plurality of nodes and direct-connect links that are arranged according to a graph structure. Each of the nodes have an equal number of outbound and inbound direct-connect links to define a node degree (d). In at least one non-limiting embodiment, the graph structure is instantiated as a generalized Kautz graph and is configured to provide high expansion properties, low diameter, and uniform path diversity for supporting scalable all-to-all collective communication.

Graphs achieving all-to-all time bound generalized Kautz graphs constitute a family of expander graphs that comes close to achieving the bound in Theorem 1. A benefit of these graphs is that one or more embodiments can generate an instance for any value of N and d. Such coverage in N and d is not possible for most graph families popular in the HPC community, such as mesh, tori, SlimFly, SpectralFly, etc. Accordingly, a generalized Kautz graph (GenKautz) can be constructed to provide coverage for varying cluster sizes and hardware configurations capable of establishing a direct-connect communication system.

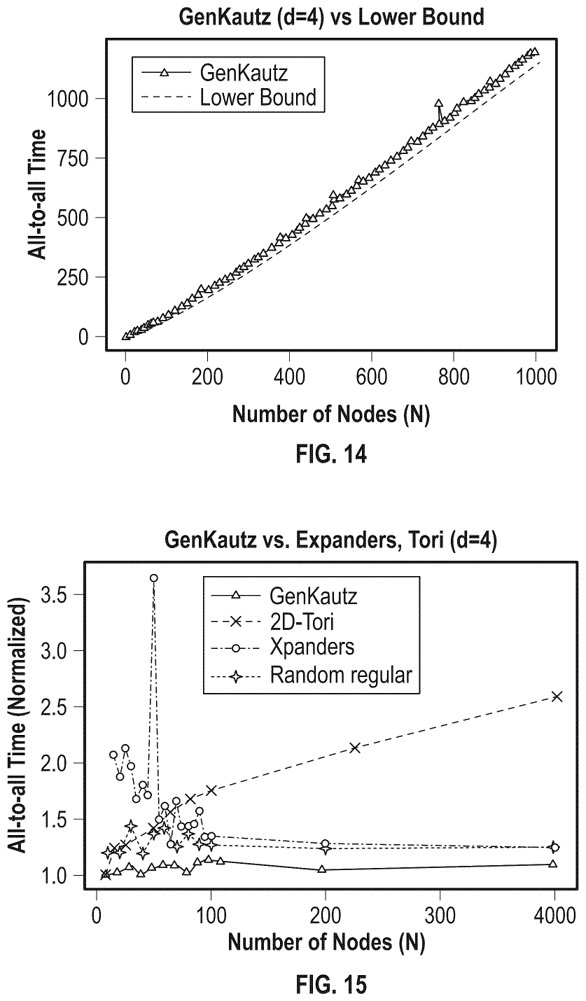

FIG. 14 shows the simulated all-to-all performance of the GenKautz graph for d=4 with respect to the derived lower bound. These graphs get very close to the all-to-all lower bound for any d-regular graph (with the ratio between the two approaching 1 for large N) thus making them optimal expanders for all-to-all collectives.

FIG. 15 compares the performance of GenKautz with non-expanders (e.g., 2D-tori) and other well-known expander graphs, e.g., Xpander and random regular graphs/Jellyfish. The last two are also known to exhibit good coverage in N and d. While the expanders significantly outperform non-expanders (for d=4, GenKautz has about 2.4 times lower latency than 2D-tori for large N), GenKautz has the best performance among the expanders (e.g., it is 10% better than Xpander and random regular graphs). Similar trends are observed for higher degrees.

One or more non-limiting embodiments generates time-stepped MCF schedules to allow for handling and managing mixed topologies (direct-connect links as well as switch↔host and switch↔switch links) to perform all-to-all communications. For example, in a common scenario servers (e.g., we have N NVIDIA H100 servers) may be implemented, with each server containing K GPUs interconnected intra-server by a fast NVSwitch fabric and inter-server by either optical direct connect NICs or electrical Infiniband switches. This leads to a hierarchical topology which can run an AI/ML or HPC workload. At least one non-limiting embodiment of the present disclosure provides a method capable of modeling the internal and external switches as nodes in a graph which can relay traffic. A MCF can then be calculated on that graph based on a set of source and destination nodes which do not include the switch nodes. Accordingly, the schedules will be optimal in their bandwidth utilization in such a network.

In one or more topologies of the present disclosure, MCF can be used to determine a direct-connect graph having the same “effective bandwidth” (thereby removing switches). This graph can then be used to compute time-stepped MCF schedules. This allows one to handle and manage mixed topologies (direct-connect links as well as switch↔host and switch↔switch links) for all-to-all communications. Accordingly, a complicated mixed topology including switches and direct connect is converted into a pure direct connect topology that operates according to an “effective bandwidth” on every direct connect link rather than having switches function as intermediaries. This provides an advantage in that once the complicated mixed topology is converted into the simpler pure direct connect topology, the time stamp MCF can then be used to compute schedules for the converted direct connect topology.

One or more non-limiting embodiments develop efficient schedules and topologies for all-to-all collective communications geared for large-scale direct connect fabrics. Results according to embodiments of the present disclosure demonstrate that the time-stepped MCF (tsMCF) approach and compiler are highly scalable and achieve near-optimal bandwidth performance in practice. This is valuable for many applications that rely on all-to-all when run on GPU (or CPU) clusters, such as deep learning training and inference. For path-based MCF-extP and pMCF, results according to embodiments of the present disclosure similarly demonstrate excellent performance in practice at the smaller 8 and 27-node scales. Path-based MCF is able to exploit additional forwarding bandwidth to speed up the collective.

When lowering path-based MCF routes to fabrics with wormhole (flit-based) routing such as Cerio, routes must be deadlock-free. One or more embodiments implemented several variants of common algorithms for breaking deadlocks, such as DF-SSSP and LASH, which assign virtual channels to routes after the routes are computed. One or more embodiments found that a variant of LASH, which one or more embodiments call LASH sequential performed best in terms of requiring the least number of layers; specifically, it required no more than 4 layers across all the algorithms (MCF, ILP, EwSP, etc.) and topologies one or more embodiments evaluated. Minimizing the number of VCs to make a given set of routes deadlock free is NP-hard.

As described above, deadlock-free routing is a practical challenge to make path-based MCF schemes work on wormhole or cut-through routed networks. For the most path one or more embodiments just implemented existing ideas (e.g., variants of LASH).

On the practical front, a limitation of path-based MCF solutions when lowered to existing fabrics is support for injection rate control. As described above, an approximation of injection rate control can be implemented by splitting shards into granular equal-sized chunks/flows and steering them on routes. While this approach works very well at an 8-node scale as a proof of concept, and achieved reasonable performance at a larger 27-node scale, it is in general not scalable. Granular chunking significantly increases the total number of active Queue Pairs (QPs) in the network. And all-to-all micro-benchmarking experiments according to embodiments of the present disclosure clearly show a reduction in the achievable per-flow bandwidth as the number of QPs increased on the Cerio fabric, likely due to increased contention. One or more embodiments of the present disclosure provide addresses this challenge by introducing time steps into the routed MCF schedules and partition the flows across multiple timesteps,.

One or more embodiments are extending the general MCF formulation and the implementation to handle and mange hybrid clustered settings with possibly severe imbalance between internal link bandwidth within a server, and external bandwidth (e.g., several Terabytes per second (TBps) internal bandwidth vs several gigabytes pers second (GBps) external bandwidth in GPU servers from NVIDIA and AMD), and with possibly internal switching. Accordingly, the all-to-all framework can naturally handle heterogeneous topologies such as ones where the link capacities are different (this is not the case in all the case studies in the paper), or the system has a hierarchical structure, e.g., 8 GPUs in an NVIDIA DGX box and multiple boxes connected via direct connect NICs or via switches (e.g., Mellanox Infiniband).

If there are switches in the topology, then in the MCF framework, they can be represented as “nodes” with incoming and outgoing links of prescribed capacities; but these nodes do not source or sink traffic—they just forward traffic flows. The MCF Linear Programs can be easily adapted to handle such scenarios. Essentially once the MCF is computed, such switches are replaced by direct links between upstream and downstream nodes with “effective capacities” as computed by MCF (e.g., referred to as switch removal). This new virtual topology is a direct-connect topology that is heterogeneous in general (since the effective capacities of the virtual links need not be equal). This heterogeneous virtual topology can then be used to compute tsMCF schedules for the non-routed case. For the routed case, paths through switches should be directly available from running MCF on the original mixed topology that has both direct connect and switches.

Various non-limiting embodiments provide: (1) Formulation and algorithm for scaling the max concurrent multi-commodity flow (MCF) framework by decomposing the MCF problem and parallelizing it for fast link-based all-to-all schedule computation; (2) Formulation and algorithms for computing a time-stepped version of MCF (for host-based); (3) For switched topologies, using MCF and creating a direct-connect graph with the same “effective bandwidth” (thereby removing switches), and then using this graph to compute time-stepped MCF schedules. This allows one to handle mixed topologies (direct-connect links as well as switch↔host and switch↔switch links) for all-to-all comms; (4) novel application of the MCF framework in a direct-connect setting on fabrics with or without additional forwarding bandwidth and/or cut-through routing where the following cases are considered—(a) source-routing might be available or not; (b) host-to-NIC link might be bottlenecked or not; (c) the number of shortest paths between source-destination pairs might be small or could grow exponentially with N; (5) Addressing practical challenges of lowering schedules and routes to both ML and HPC runtimes and interconnects with different routing and flow control requirements; and (6) Identification of a direct-connect topology that delivers near optimal performance for all-to-all (generalized Kautz graphs for any N,d)—this required developing an analytical lower bound for all-to-all performance and shown that the identified topology approaches the bound.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of performing all-to-all collective communication scheduling, the method comprising:
scaling a max concurrent multi-commodity flow (MCF) framework by decomposing a MCF problem and parallelizing the MCF problem to perform a fast link-based all-to-all schedule computation;
computing a time-stepped version of the MCF problem for a host-based forwarding network topology;
utilizing the time-stepped version of the MCF problem to create a direct-connect graph, and then using the direct-connect graph to compute time-stepped MCF schedules to manage a mixed topology; and
performing an identification of a direct-connect topology to perform all-to-all collective communication based on the time-stepped MCF schedules.

2. The method of claim 1, wherein the mixed topology includes a combination of direct-connect links, switch-to-host links and switch-to-switch links.

3. The method of claim 1, wherein performing the identification of the direct-connect topology utilizes generalized Kautz graphs for any N,d.

4. The method of claim 3, wherein performing the identification of the direct-connect topology develops an analytical lower bound for all-to-all performance and shown that the identified topology approaches the bound.

5. A method for performing all-to-all collective communication scheduling in a direct-connect topology, the method comprising:
generating a communication schedule for executing an all-to-all collective communication operation among a plurality of nodes interconnected by a direct-connect topology, wherein the schedule defines transmission of data between nodes while optimizing communication performance;
determining communication paths for data transfer between nodes, wherein the communication paths are selected to optimize concurrent data transmission across the direct-connect topology;
allocating communication resources to ensure efficient utilization of available bandwidth across the direct-connect topology; and
executing the all-to-all collective communication by transmitting data among the nodes in accordance with the generated communication schedule.

6. The method of claim 5, wherein the communication schedule is generated based on a multi-commodity flow (MCF) optimization framework that maximizes concurrent throughput across all nodes.

7. The method of claim 6, wherein the communication paths are determined using a decomposed linear programming approach, and wherein an MCF problem is partitioned into a master linear program (LP) and a plurality of parallel child LPs.

8. The method of claim 5, wherein the direct-connect topology is modeled as a graph structure with nodes representing computing devices and edges representing communication links between the computing devices.

9. The method of claim 8, wherein executing the all-to-all collective communication further includes performing a time-stepped scheduling to transmit data transmitted in discrete time intervals.

10. A direct-connect network for executing all-to-all collective communication among a plurality of nodes, the direct-connect network comprising:
a plurality of nodes, each of the nodes configured to operate as both a source and a destination for data communication;
a plurality of direct-connect links interconnecting the nodes, each of the direct-connect links having a defined bandwidth;
wherein the direct-connect network is structured to support concurrent communication among each of the node pairs included in the plurality of direct-connect links, and
wherein the arrangement of the nodes and the direct-connect links is configured to facilitate all-to-all communication scheduling by enabling each node to transmit and receive multiple data flows concurrently.

11. The direct-connect network of claim 10, wherein the plurality of nodes and the plurality of direct-connect links are arranged according to a graph structure, and wherein each of the nodes having an equal number of outbound and inbound direct-connect links included in the plurality of direct-connect links to define a node degree (d).

12. The direct-connect network of claim 11, wherein the graph structure is instantiated as a generalized Kautz graph and is configured to provide high expansion properties, low diameter, and uniform path diversity for supporting scalable all-to-all collective communication.

13. The direct-connect network of claim 12, wherein the generalized Kautz graph is constructed to provide coverage for varying cluster sizes and hardware configurations.

14. The direct-connect network of claim 13, wherein the topology is configured to support multi-commodity flow-based scheduling of data transfers configured to balance communication loads across multiple concurrent paths between source and destination node pairs.

15. The direct-connect network of claim 10, wherein each of the plurality of direct-connect links connect at least one pair of nodes absent intermediary switching devices.
